(19) United States
(12) Patent Application Publication
(10) Pub. No.: US 2012/0039090 A1
(43) Pub. Date: Feb. 16, 2012

(54) SURFACE LIGHT SOURCE DEVICE AND DISPLAY APPARATUS USING THE SAME

(75) Inventors: Hui-Yi JIANG, Suzhou (CN); An-Dong Li, Suzhou (CN)

(73) Assignee: Coretronic (Suzhou) Corporation, Suzhou (CN)

(21) Appl. No.: 13/097,769

(22) Filed: Apr. 29, 2011

(30) Foreign Application Priority Data
Aug. 13, 2010 (CN) 201010254413.4

(51) Int. Cl. F21V 8/00

(52) U.S. Cl. 362/613

(57) ABSTRACT

A surface light source device and a display apparatus using the same are provided. The surface light source device includes a light guide plate, a light source assembly, and at least one protecting frame. The light guide plate has a light incident surface. The light source assembly includes a substrate and a plurality of point light sources disposed on the substrate. A light emitting surface of each point light source faces the light incident surface of the light guide plate. The protecting frame is disposed on the substrate and surrounds at least a part of the point light sources. A distance between a top surface of the protecting frame facing the light incident surface and the substrate is larger than a distance between the light emitting surface of each point light source and the substrate. The surface light source device and the display apparatus have better light utilization efficiency.

### FIELD OF THE INVENTION

The invention relates to a surface light source device, and more particularly to a surface light source device having a light guide plate and to a display apparatus using the surface light source device.

### BACKGROUND OF THE INVENTION

Backlight modules are applied in liquid crystal display devices to provide display light to the liquid crystal display panels. Backlight modules include bottom lighting backlight modules and edge lighting backlight modules. Technologies about the edge lighting backlight modules are disclosed in many patents, such as Taiwan patents No. I315015, M270369, and M303389, Taiwan published applications No. 200809318, 200727040, 200815870, and 200813592, U.S. Pat. No. 7,545,461, and United States published applications No. 20070029915, 20050253980, 20090256987 and so on.

Referring to FIG. 1, a conventional edge lighting backlight module 100 includes a light guide plate 110 and a light source assembly 120. The light guide plate 110 has a light incident surface 112 and a light emitting surface 114 adjacent to the light incident surface 112. The light source assembly 120 is disposed beside the light incident surface 112. Moreover, the light source assembly 120 includes a circuit board 122 and a plurality of light emitting diodes 124 disposed on the circuit board 122. The light emitting diodes 124 are capable of providing light for the light guide plate 110. After the light enters the light guide plate 110 via the light incident surface 112, the light guide plate 110 converts the light into a surface light source, and the surface light source is emitted from the light emitting surface 114. The surface light source may be used as display light source for the liquid crystal display panel.

In the conventional technology, the light emitting diodes 124 generate heat when the light emitting diodes 124 are lightened, thereby resulting in heat expansion of the light guide plate 110. When the expanded light guide plate 110 jostles the light emitting diodes 124, the light emitting diodes 124 may be damaged. In order to prevent the expanded light guide plate 110 from jostling the light emitting diodes 124, a sufficient gap G between the light guide plate 110 and the light emitting diodes 124 should be kept. However, light utilization efficiency of the backlight module 100 may be reduced.

### SUMMARY OF THE INVENTION

The invention provides a surface light source to promote light utilization efficiency.

The invention also provides a display apparatus to promote light utilization efficiency.

In order to achieve one or a portion of or all of the objects or other objects, an embodiment of the invention provides a surface light source device. The surface light source device includes a light guide plate, a light source assembly, and at least one protecting frame. The light guide plate has a light incident surface. The light source assembly includes a substrate and a plurality of point light sources disposed on the substrate. A light emitting surface of each of the point light sources faces the light incident surface of the light guide plate. The protecting frame is disposed on the substrate and surrounds at least a part of the point light sources. A distance between a top surface of the protecting frame facing the light incident surface and the substrate is larger than a distance between the light emitting surface of each point light source and the substrate.

In one embodiment of the invention, the top surface of the protecting frame abuts the light guide plate.

In one embodiment of the invention, the surface light source device includes a plurality of the protecting frames, each of the protecting frames surrounds one of the point light sources, and a number of the protecting frames is equal to a number of the point light sources.

In one embodiment of the invention, the surface light source device includes a plurality of the protecting frames, each of the protecting frames surrounds one of the point light sources, and a number of the protecting frames is smaller than a number of the point light sources.

In one embodiment of the invention, the surface light source device includes a plurality of the protecting frames, and each protecting frame surrounds at least one of the point light sources.

In one embodiment of the invention, a material of the protecting frame includes a flexible material.

In one embodiment of the invention, the flexible material includes a rubber or a plastic.

In one embodiment of the invention, the protecting frame further has a bottom surface abutting the substrate, and a caliber of the protecting frame is gradually decreased from the top surface to the bottom surface.

In one embodiment of the invention, an inner surface of the protecting frame is a reflecting surface.

In one embodiment of the invention, a color of the protecting frame is white.

In one embodiment of the invention, the surface light source device further includes a reflecting layer disposed on an inner surface of each protecting frame.

In one embodiment of the invention, a color of the reflecting layer is white.

The invention also provides a display apparatus. The display apparatus includes a display panel and the above-mentioned surface light source device. The surface light source device is disposed beside the display panel.

In summary, the embodiment or embodiments of the invention may have at least one of the following advantages. In the surface light source device according to embodiments of the invention, since the at least one protecting frame disposed on the substrate is used to prevent the expanded light guide plate from jostling the point light sources, a gap between the light guide plate and the point light sources may be as small as possible, so as to promote the light utilization efficiency. Furthermore, the display apparatus according to embodiments of the invention uses the surface light source device. Thus, the display apparatus has better light utilization efficiency.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 is a schematic view of a conventional edge lighting backlight module.

FIG. 2 is a schematic, top view of a surface light source device according to an embodiment of the invention.

FIG. 3 is a schematic, three-dimensional view of a light source assembly and protecting frames of FIG. 2.

FIG. 4 is a schematic, three-dimensional view of a light source assembly and protecting frames according to another embodiment of the invention.

FIG. 5 is a schematic, three-dimensional view of a light source assembly and protecting frames according to another embodiment of the invention.

FIG. 6 is a schematic, three-dimensional view of a protecting frame according to another embodiment of the invention.

FIG. 7 is a schematic view of a display apparatus according to an embodiment of the invention.

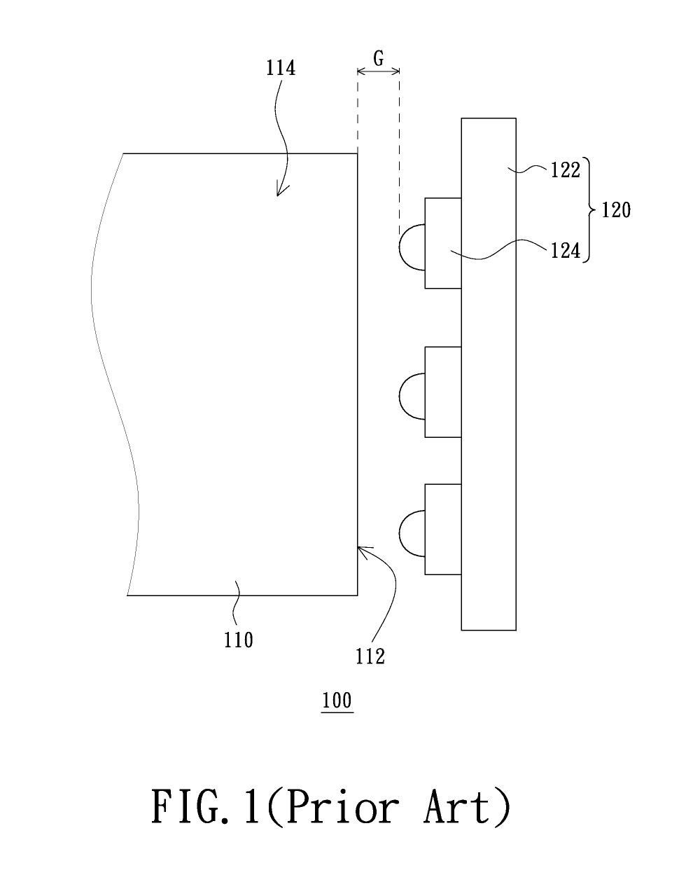

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

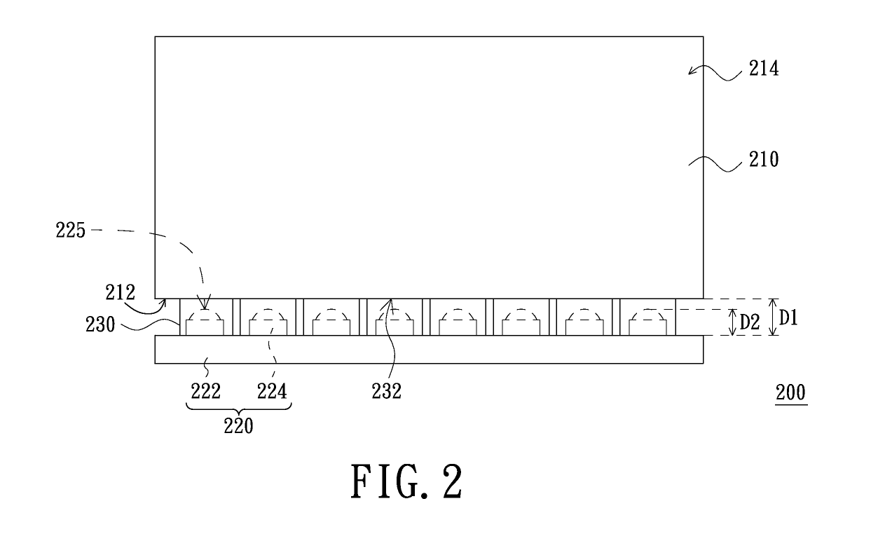

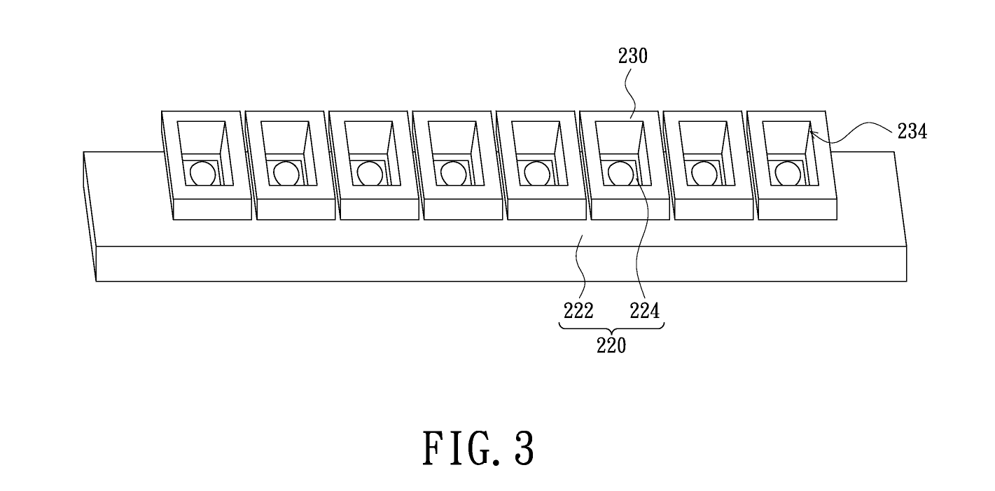

Referring to FIG. 2 and FIG. 3, a surface light source device 200 of the embodiment includes a light guide plate 210, a light source assembly 220, and at least one protecting frame 230 (a plurality of the protecting frames 230 are taken as an example in the embodiment). The light guide plate 210 has a light incident surface 212. The light source assembly 220 includes a substrate 222 and a plurality of point light sources 224 disposed on the substrate 222. The point light sources 224 may be light emitting diodes or other suitable point light sources. A light emitting surface 225 of each of the point light sources 224 faces to the light incident surface 212 of the light guide plate 210. The protecting frames 230 are disposed on the substrate 222, and each of the protecting frames 230 surrounds at least a part of the point light sources 224. In the embodiment, each protecting frame 230, for example, surrounds a point light source 224. A number of the protecting frames 230 is equal to a number of the point light sources 224, that is, each of the point light sources 224 is surrounded by one protecting frame 230. In addition, a distance D1 between a top surface 232 of the protecting frame 230 facing the light incident surface 212 and the substrate 222 is larger than a distance D2 between the light emitting surface 225 of each of the point light sources 224 and the substrate 222.

In the embodiment, the above-mentioned top surface 232 of the protecting frame 230 abuts the light guide plate 210. However, in other embodiments, the top surface 232 of the protecting frame 230 may be kept a gap from the light incident surface 212 of the light guide plate 210. Additionally, a material of the protecting frame 230 may be a flexible material, such as a rubber or a plastic and so on. Moreover, the protecting frames 230 of the embodiment are, for example, rectangle frames. However, the protecting frames 230 may also be circular frames or oval-shaped frames, and the invention does not limit the shape of the protecting frames.

In the surface light source device 200, light provided by the point light sources 224 enters the light guide plate 210 via the light incident surface 212 of the light guide plate 210. The light guide plate 210 converts the light into a surface light source, and the surface light source is emitted from a light emitting surface 214 of the light guide plate 210. The point light sources 224 generate heat when the point light sources 224 are lightened, thereby resulting in heat expansion of the light guide plate 210. Therefore, in the embodiment, the protecting frames 230 are disposed on the substrate 222, and the distance D1 between the top surface 232 of the protecting frames 230 and the substrate 222 is larger than the distance D2 between the light emitting surface 225 of each of the point light source 224 and the substrate 222. When the heat generated by the point light source 224 cause the light guide plate 210 to be expanded, the light guide plate 210 may jostle the protecting frames 230 but not the point light sources 224. In such way, not only the point light sources 224 are prevented from damage caused by jostle of the light guide plate 210, but also a gap between the point light sources 224 and the light guide plate 210 may be as small as possible, so as to promote light utilization efficiency of the surface light source device 200.

Furthermore, since the protecting frames 230 may be made of flexible material, the protecting frames 230 may be deformed under the jostle of the light guide plate 210, and thereby the light guide plate 210 may expand towards the point light sources 224. If the light guide plate 210 does not expand towards the point light sources 224, a bump of the light guide plate 210 may be formed. However, in the embodiment, the bump may not be formed because the light guide plate 210 may expand towards the point light sources 224. In addition, in the embodiment, the material of the protecting frames 230 may has high reflectivity so that an inner surface 234 of each protecting frame 230 may be used as a reflective surface to promote the light utilization efficiency. In order to prevent the color of the light reflected by the protecting frames 230 from being changed, a color of the protecting frames 230 may be corresponded with the color of the light emitted by the point light sources 224. For example, when the point light sources 224 are white point light sources, the color of the protecting frames 230 may be white.

Although in the embodiment, the protecting frames 230 are, for example, made of the material with the high reflectivity, in another embodiment, a reflecting layer (not shown) may be directly disposed on the inner surface 234 of each protecting frame 230. The reflecting layer is configured to reflect light. In addition, a color of the reflecting layer may be corresponded with the color of the light emitted by the point light sources 224. For example, the colors of the reflecting layer and the color of the light emitted by the point light sources 224 may be white.

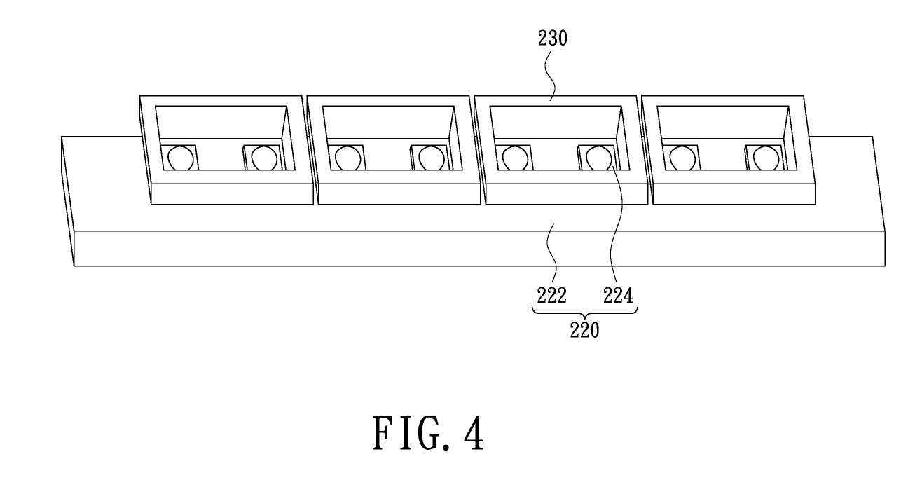

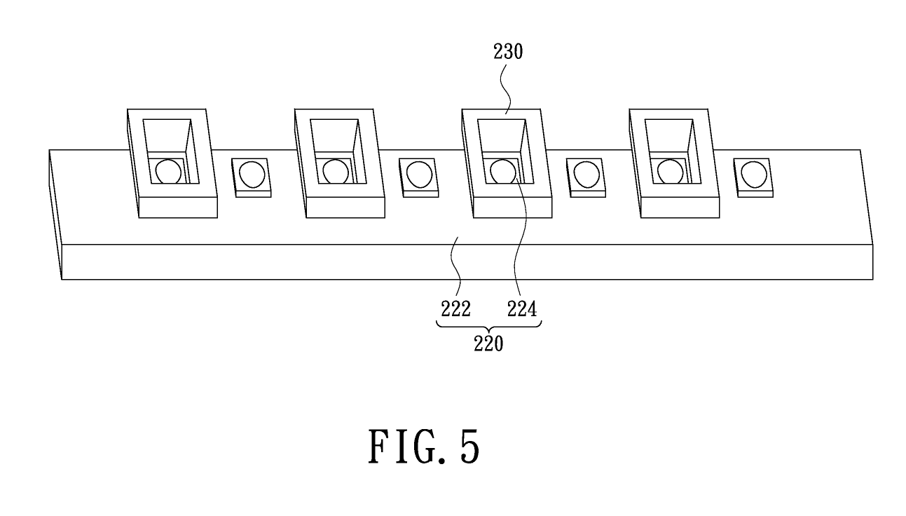

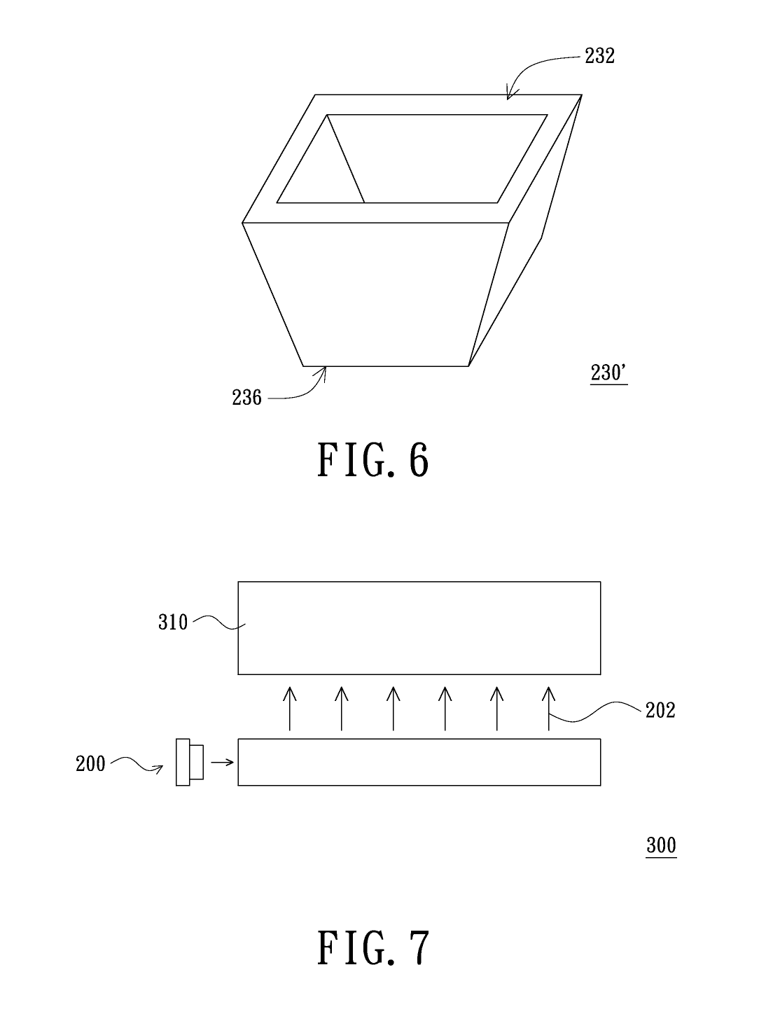

In the invention, a protecting frame 230 is not limited to only surrounds a point light source 224, that is, the protecting frame 230 may surrounds at least one of the point light sources 224. Referring to FIG. 4, FIG. 5, and FIG. 6, as shown in FIG. 4, each protecting frame 230 may surround two point light sources 224. Moreover, the invention does not limit that each of the point light sources 224 should be surrounded by the protecting frame 230. For example, as shown in FIG. 5, each of the protecting frames 230 surrounds one of the point light sources 224, and a number of the protecting frames 230 is smaller than a number of the point light sources 224. In addition, as shown in FIG. 6, in another embodiment, a caliber of a protecting frame 230′ is gradually decreased from the top surface 232 to a bottom surface 236 abutting the substrate (not shown) of the light source assembly, and thereby the light utilization efficiency may be promoted.

The surface light source device 200 may be applied in a display apparatus to provide a display light to a display panel of the display apparatus. However, the invention does not limit the applications of the surface light source device 200.

Referring to FIG. 7, a display apparatus 300 of the embodiment includes a display panel 310 and the above-mentioned surface light source device 200, and the surface light source device 200 provides display light 202 to the display panel 310. The display panel 310 may be, but not limited to, a liquid crystal display panel. Since the light utilization efficiency of the surface light source device 200 applied in the display apparatus 300 is high, light utilization efficiency of the display apparatus 300 of the embodiment may be promoted.

In summary, the surface light source device and the display apparatus using the same according to embodiments of the invention at least have one of the following advantages:

1. In the surface light source device according to embodiments of the invention, the at least one protecting frame disposed on the substrate is used to prevent the expanded light guide plate from jostling the point light sources disposed on the substrate. Therefore, the gap between the light guide plate and the point light sources may be as small as possible, so as to promote the light utilization efficiency.

2. The at least one protecting frame of the surface light source device according to embodiments of the invention may be made of the flexible material. In such way, when the expanded light guide plate jostles the protecting frame, the protecting frame is deformed, and thereby the light guide plate may expand towards the point light sources and the bump of the light guide plate may be avoided.

3. The display apparatus according to embodiments of the invention uses the surface light source having high light utilization efficiency. Thus, the light utilization efficiency of the display apparatus is high.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A surface light source device comprising:
a light guide plate having a light incident surface;
a light source assembly comprising a substrate and a plurality of point light sources disposed on the substrate, wherein a light emitting surface of each of the point light sources faces the light incident surface of the light guide plate; and
at least one protecting frame disposed on the substrate, wherein the protecting frame surrounds at least a part of the point light sources, and a distance between a top surface of the protecting frame facing the light incident surface and the substrate is larger than a distance between the light emitting surface of each of the point light sources and the substrate.

2. The surface light source device according to claim 1, wherein the top surface of the protecting frame abuts the light guide plate.

3. The surface light source device according to claim 1, wherein the at least one protecting frame comprises a plurality of the protecting frames, each of the protecting frames surrounds one of the point light sources, and a number of the protecting frames is equal to a number of the point light sources.

4. The surface light source device according to claim 1, wherein the at least one protecting frame comprises a plurality of the protecting frames, each of the protecting frames surrounds one of the point light sources, and a number of the protecting frames is smaller than a number of the point light sources.

5. The surface light source device according to claim 1, wherein a material of the protecting frame comprises a flexible material.

6. The surface light source device according to claim 5, wherein the flexible material comprises a rubber or a plastic.

7. The surface light source device according to claim 1, wherein the protecting frame further has a bottom surface abutting the substrate, and a caliber of the protecting frame is gradually decreased from the top surface to the bottom surface.

8. The surface light source device according to claim 1, wherein an inner surface of the protecting frame is a reflecting surface.

9. The surface light source device according to claim 8, wherein a color of the protecting frame is white.

10. The surface light source device according to claim 1, further comprising a reflecting layer disposed on an inner surface of the protecting frame.

11. The surface light source device according to claim 10, wherein a color of the reflecting layer is white.

12. A display apparatus comprising:
a display panel;
a surface light source device disposed beside the display panel, wherein the surface light source device comprises:
a light guide plate having a light incident surface;
a light source assembly comprising a substrate and a plurality of point light sources disposed on the substrate, wherein a light emitting surface of each of the point light sources faces the light incident surface of the light guide plate; and
at least one protecting frame disposed on the substrate, wherein the protecting frame surrounds at least a part of the point light sources, and a distance between a top surface of the protecting frame facing the light incident surface and the substrate is larger than a distance between the light emitting surface of each point light source and the substrate.

13. The display apparatus according to claim 12, wherein the top surface of the protecting frame abuts the light guide plate.

14. The display apparatus according to claim 12, wherein the at least one protecting frame comprises a plurality of the protecting frames, each of the protecting frames surrounds one of the point light sources, and a number of the protecting frames is equal to a number of the point light sources.

15. The display apparatus according to claim 12, wherein the at least one protecting frame comprises a plurality of the protecting frames, each of the protecting frames surrounds one of the point light sources, and a number of the protecting frames is smaller than a number of the point light sources.

16. The display apparatus according to claim 12, wherein the at least one protecting frame comprises a plurality of the protecting frames, and each of the protecting frames surrounds at least one of the point light sources.

17. The display apparatus according to claim 12, wherein a material of the protecting frame comprises a flexible material.

18. The display apparatus according to claim 17, wherein the flexible material comprises a rubber or a plastic.

19. The display apparatus according to claim 12, wherein the protecting frame further has a bottom surface abutting the substrate, and a caliber of the protecting frame is gradually decreased from the top surface to the bottom surface.

20. The display apparatus according to claim 12, wherein an inner surface of the protecting frame is a reflecting surface.

21. The display apparatus according to claim 20, wherein a color of the protecting frame is white.

22. The display apparatus according to claim 12, further comprising a reflecting layer disposed on an inner surface of the protecting frame.

23. The display apparatus according to claim 22, wherein a color of the reflecting layer is white.
